(19) United States
(12) Patent Application Publication
(10) Pub. No.: US 2013/0003242 A1
(43) Pub. Date: Jan. 3, 2013

(54) TRANSIENT VOLTAGE SUPPRESSOR FOR MULTIPLE PIN ASSIGNMENTS

(76) Inventors: Kun-Hsien LIN, Hsinchu City (TW); Che-Hao Chuang, Hsinchu City (TW); Ryan Hsin-Chin Jiang, Taipei City (TW)

(21) Appl. No.: 13/612,253

(22) Filed: Sep. 12, 2012

Related U.S. Application Data
(63) Continuation-in-part of application No. 12/836,745, filed on Jul. 15, 2010.

(51) Int. Cl. H02H 3/22

(52) U.S. Cl. 361/111

(57) ABSTRACT

A transient voltage suppressor (TVS) for multiple pin assignments is disclosed. The suppressor comprises at least two cascade-diode circuits in parallel to each other and an electrostatic-discharge clamp element in parallel to each cascade-diode circuit and connected with a low voltage.

One cascade-diode circuit is connected with a high voltage, and the other cascade-diode circuits are respectively connected with I/O pins. Each cascade-diode circuit further comprises a first diode and a second diode cascaded to the first diode, wherein a node between the first diode and the second diode is connected with the high voltage or the one I/O pin. The design of the present invention can meet several bounding requirements. It is flexible different pin assignments of TVS parts.

### RELATED APPLICATIONS

The present invention is a continuous-in-part application of the application that is entitled “TRANSIENT VOLTAGE SUPPRESSOR FOR MULTIPLE PIN ASSIGNMENTS” (Application NO.: U.S. 12/836,745), which is filed presently with the U.S. Patent & Trademark Office, and which is used herein for reference in its entirety.

### BACKGROUND OF THE INVENTION

1. Field of the Invention

The present invention relates to a transient voltage suppressor, particularly to a transient voltage suppressor for multiple pin assignments.

2. Description of the Related Art

Because the IC device sizes have been shrunk to nanometer scale, the consumer electronics, like the laptop and mobile devices, have been designed to be much smaller than ever. Without suitable protection devices, the functions of these electronics could be reset or even damaged under ESD (Electrostatic Discharge) events. Currently, all consumer electronics are expected to pass the ESD test requirement of IEC 61000-4-2 standard. TVS (Transient Voltage Suppressor) is generally designed to bypass the ESD energy, so that the electronic systems can be prevented from ESD damages. The working principle of TVS is shown in FIG. 1. In FIG. 1, the TVS devices 10 are connected in parallel with the protected circuits 12 on the PCB (Printed Circuit Board). These TVS devices 10 would be triggered immediately when the ESD event is occurred. In that way, each TVS device 10 can provide a superiorly low resistance path for discharging the transient ESD current, so that the energy of the ESD transient current can be bypassed by the TVS devices 10.

As the TVS device 10 used as ESD protector for different applications, for example, USB port, VGA port, and HDMI port, etc., the pin assignments of TVS parts should be changed to meet the suitable PCB layout for different applications. In addition, for high-speed applications, for example, USB port, HDMI port, etc., the parasitic capacitance of I/O pin of TVS should be low enough to avoid malfunction. The TVS design of two I/O pins 18 and 24 with a first diode 14, a second diode 16, a third diode 20, a fourth diode 22, and a power-rail ESD clamp element 26 between Vcc-to-GND is widely used to meet low parasitic capacitance spec. and to provide effective ESD protection at the same time, as shown in FIG. 2. However, for different pin assignments of TVS parts, the TVS chips in prior arts should be re-designed to meet relative bonding requirement. FIG. 3 and FIG. 4 show an example of the disadvantages of the prior arts. In this example, when the position of Vcc pin 28 is changed, the position of a contact area 30 connected with Vcc pin 28 on the TVS chip will be changed to correspond Vcc pin 28. In other words, the layout of the TVS chip has to be re-designed to meet relative bonding requirement. As a result, the cost of masks for fabrication process will be increased. Briefly, for different pin assignments of TVS parts, the designs of TVS chips should be different to meet each different pin assignment. Therefore, how to design single TVS chip that is available for different pin assignments is a challenge.

U.S. Pat. No. 7,579,632 only disclosed the breakdown voltage of the zener diode. As s result, when the Vcc pin is connected with the zener diode, the TVS is not turned on in normal operation. Besides, the reference further disclosed the channel 22 can connect with the Vcc pin in specification. However, “first doping concentration is no less than approximately 1*10¹⁹ atoms/cm³” is described in CLAIM of the reference. According to the reason, the breakdown voltage of the diode 21 is less than 10 V and cannot be larger than 2 Vcc (Vcc=5V), so that the ESD endurance is degraded.

To overcome the abovementioned problems, the present invention provides a transient voltage suppressor for multiple pin assignments, so as to solve the afore-mentioned problems of the prior art.

### SUMMARY OF THE INVENTION

A primary objective of the present invention is to provide a transient voltage suppressor for multiple pin assignments, wherein a high voltage is connected with a node between two diodes of at least one cascade-diode circuit. This layout of the suppressor can reduce the cost of masks for fabrication process and improve the time-to-market of product at the same time.

To achieve the abovementioned objectives, the present invention provides a transient voltage suppressor for multiple pin assignments, which comprises at least two cascade-diode circuits in parallel to each other and an electrostatic-discharge clamp element in parallel to each cascade-diode circuit and connected with a low voltage. One of the cascade-diode circuits is connected with a high voltage, and the other cascade-diode circuits are respectively connected with I/O pins. Each cascade-diode circuit further comprises a first diode and a second diode cascaded to the first diode, wherein a node between the first diode and the second diode is connected with the high voltage or the one I/O pin.

Below, the embodiments are described in detail in cooperation with the drawings to make easily understood the technical contents, characteristics and accomplishments of the present invention.

### BRIEF DESCRIPTION OF THE DRAWINGS

FIG. 1 is a circuit diagram showing a transient voltage suppressor connected with a protected circuit according to the prior art;

FIG. 2 is a circuit diagram showing the transient voltage suppressor according to the prior art;

FIG. 3 is a circuit and bonding layout meeting a pin assignment according to FIG. 2;

FIG. 4 is a circuit and bonding layout meeting another pin assignment according to FIG. 2;

FIG. 5 is a circuit diagram showing a transient voltage suppressor with an electrostatic-discharge clamp element according to an embodiment of the present invention;

FIG. 6 is a circuit diagram showing a transient voltage suppressor with a Zener diode according to an embodiment of the present invention;

FIG. 7 is a circuit and bonding layout meeting a pin assignment according to FIG. 6;

FIG. 8 is a circuit and bonding layout meeting another pin assignment according to FIG. 6;

FIG. 9 is a diagram schematically showing the path of the ESD current moving from Vcc pin to grounding voltage according to an embodiment of the present invention;

FIG. 10 is a diagram schematically showing the path of the ESD current moving from grounding voltage to Vcc pin according to an embodiment of the present invention;

FIG. 11 is a diagram schematically showing two paths of the ESD current moving from Vcc pin to grounding voltage according to an embodiment of the present invention; and

FIG. 12 is a diagram showing ESD I-V characteristic curves of a Path 1 and a Path 2 according to an embodiment of the present invention.

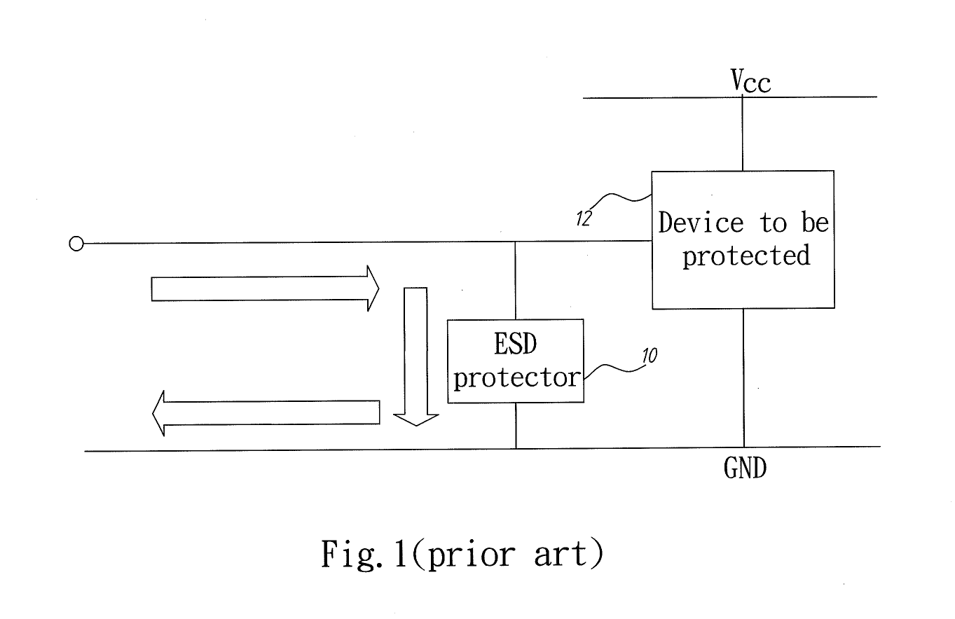

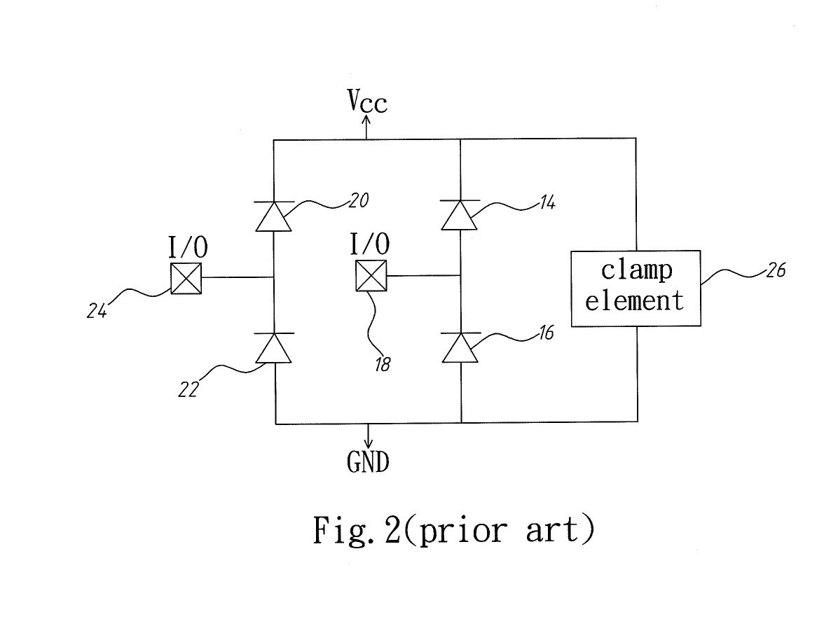

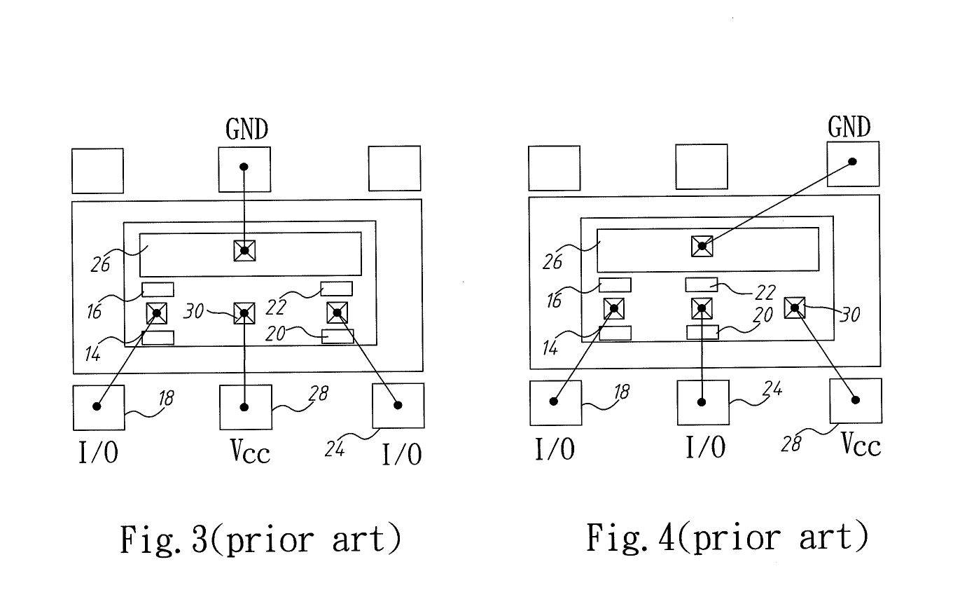

### DETAILED DESCRIPTION OF THE INVENTION

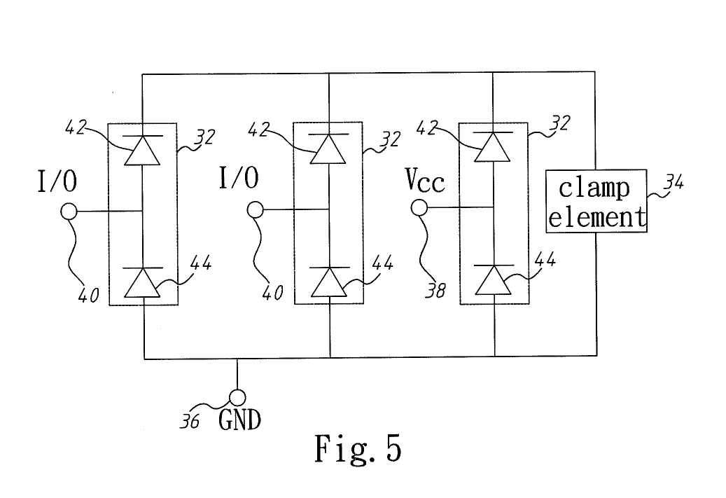

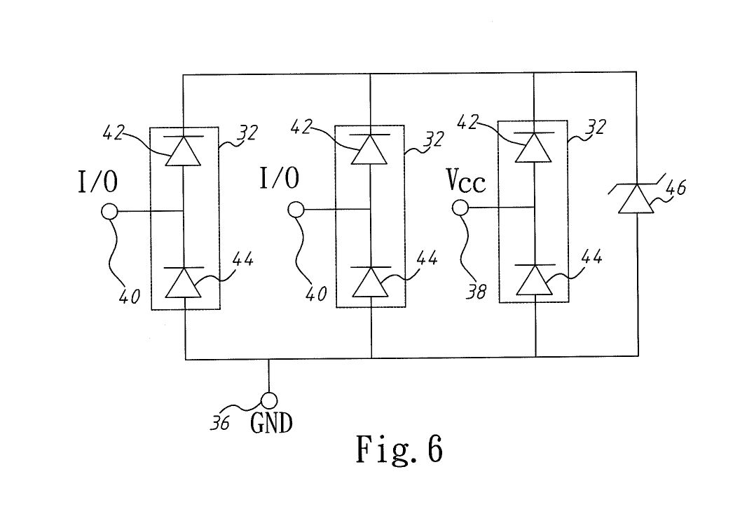

Refer to FIG. 5 and FIG. 6. The present invention comprises at least two cascade-diode circuits 32 in parallel to each other and an electrostatic-discharge clamp element 34 in parallel to each cascade-diode circuit 32 and connected with a low voltage, such as a grounding voltage.

A ground pin 36 in FIG. 5 and FIG. 6 denotes the grounding voltage. One of the cascade-diode circuits 32 is connected with a high voltage such as Vcc voltage, and the other cascade-diode circuits 32 are respectively connected with I/O pins 40. A Vcc pin 38 in FIG. 5 and FIG. 6 denotes the Vcc voltage. Each cascade-diode circuit 32 further comprises a first diode 42 and a second diode 44 cascaded to the first diode 42. According to the above-mentioned, a node between the first diode 42 and the second diode 44 is connected with the Vcc pin 38 or the one I/O pin 40. In the embodiment, the number of the cascade-diode circuits 32 is three, which is used as an example. In addition, the electrostatic-discharge clamp element 34 is exemplified by a Zener diode 46 as shown in FIG. 6.

Specifically, the cathode and the anode of the Zener diode 46 are respectively connected with the cathode of the first diode 42 and the anode of the second diode 44. The anode of the first diode 42 is connected with the cathode of the second diode 44, and the anode of the second diode 44 is connected with the grounding pin 36.

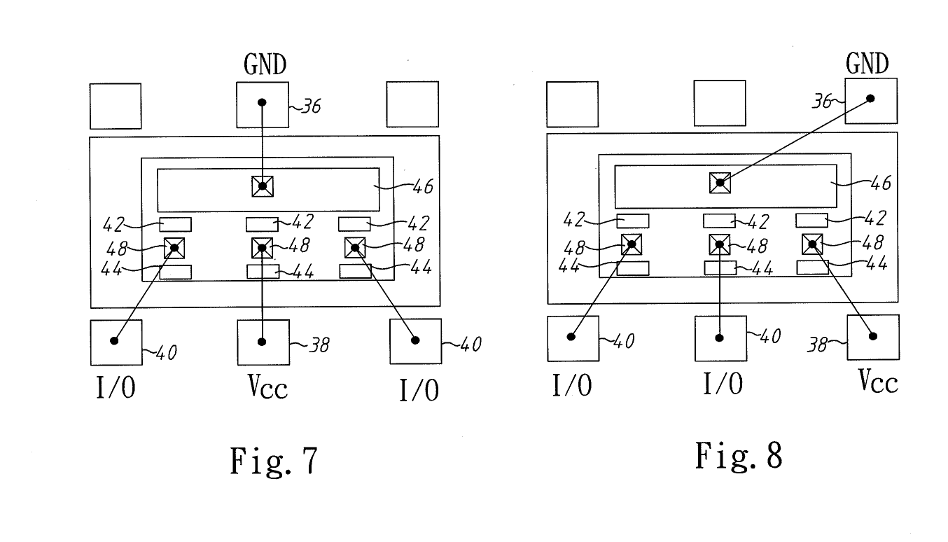

Refer to FIG. 7 and FIG. 8, wherein FIG. 7 and FIG. 8 are the circuit and bonding layout of FIG. 6. Since the first and second diodes 42 and 44 of each cascade-diode circuits 32 is connected with the Vcc pin 38 or the I/O pin 40, a contact area 48 is disposed between the first and second diodes 42 and 44 to be connected with the Vcc pin 38 or the I/O pin 40. FIG. 7 and FIG. 8 are the layouts, which meet two different pin assignments respectively. When the position of the Vcc pin 38 has to be changed, the positions of the Vcc pin 38 and the I/O pin 40 can be exchanged. Besides, the layout of the transient voltage suppressor needn't be re-designed. The original contact area 48 is used to be connected with the changed Vcc pin 38 or the changed I/O pin 40. As a result, the present invention can reduce the cost of chip development, for example, the cost of mask for fabrication process, and improve the time-to-market of product at the same time. The single chip of the present invention can meet several bonding requirements and each different pin assignment.

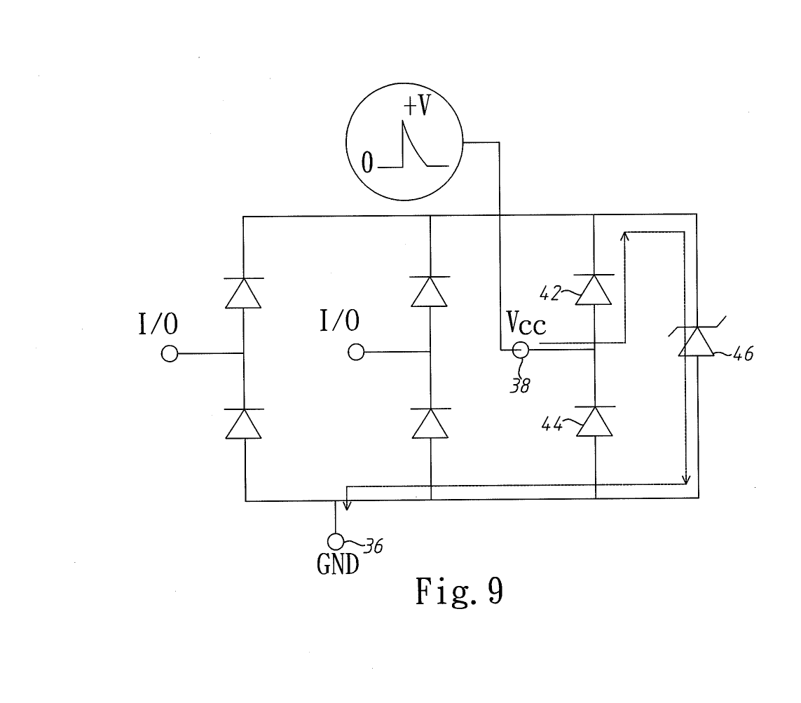

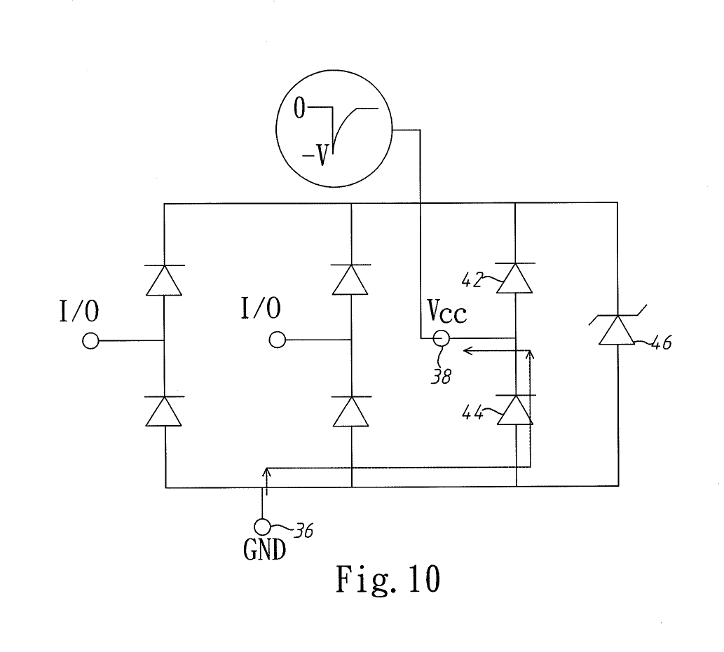

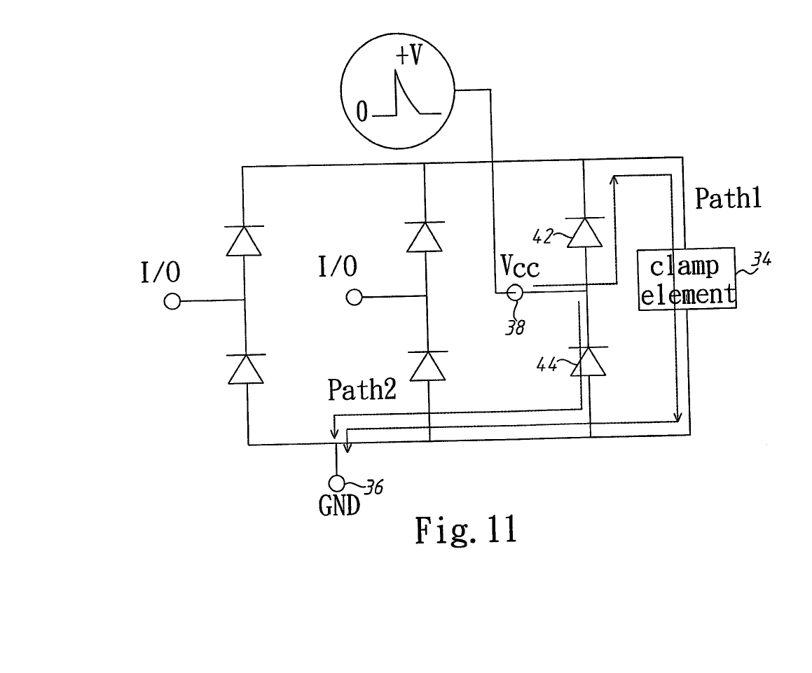

The electrostatic discharge (ESD) protection of the present invention is described as below. Refer to FIG. 9. When a positive surge voltage appears at the Vcc pin 38, an ESD current is drained out via the Vcc pin 38, the first diode 42, the Zener diode 46 and the grounding pin 36. On the contrary, refer to FIG. 10, when a negative surge voltage appears at the Vcc pin 38, an ESD current is drained out via the grounding pin 36, the second diode 44 and the Vcc pin 38.

Refer to FIG. 6 again. By the same token, when there is a plurality of cascade-diode circuits 32, the node between the first and second diodes 42 and 44 of at least one cascade-diode circuits 32 is connected with the Vcc pin 38, and the nodes of other cascade-diode circuits 32 are respectively connected with the I/O pins 40. For instance, in FIG. 6, one of the cascade-diode circuits 32 can be connected with the I/O pin 40, and the others can be respectively connected with the Vcc pins 38.

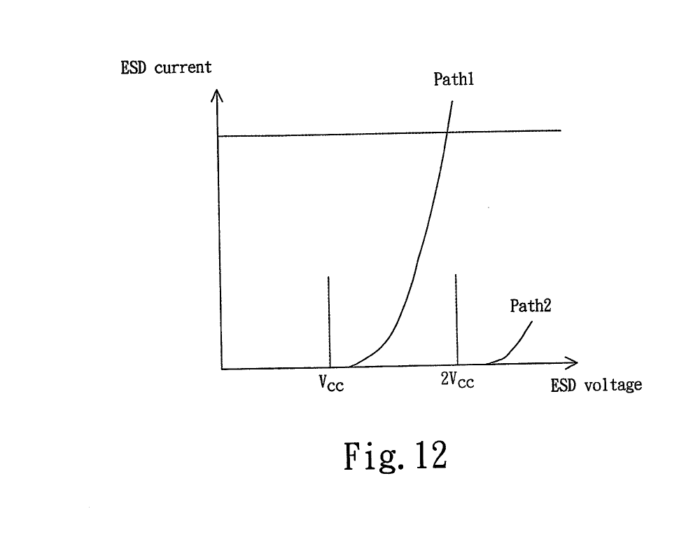

Refer to FIG. 11 and FIG. 12. When the positive ESD pulse occurs at the Vcc pin 38, the ESD current paths are shown in FIG. 11. The ESD current paths comprise Path 1 and Path 2. Path 1 is the expected ESD path passing through the first diode 42, the electrostatic-discharge clamp element 34, and the grounding pin 36. Besides, another path may be generated, as shown by Path 2. Path 2 passes through the second diode 44 and the grounding pin 36. When the higher ESD current is generated, the forward voltage of the first diode 42 plus the ESD clamping voltage of the electrostatic-discharge clamp element 34 exceeds the reverse breakdown voltage of the second diode 44, meanwhile, the reverse breakdown of the second diode 44 occurs. When the ESD event occurs, the I-V curves of Path 1 and Path 2 are shown in FIG. 12. The device size of the second diode 44 is very small taking into consideration of low capacitance for I/O. And, a diode can only endure very small ESD current in reverse breakdown. As a result, when the reverse breakdown of the second diode 44 occurs, the second diode 44 cannot endure the stress of the ESD current to fail. Therefore, define the breakdown voltage of the second diode 44 to make sure of ESD endurance of the TVS.

The reason to define that breakdown voltage of the second diode 44 is larger than 2 Vcc: By ESD TEST standard IEC 61000-4-2, the peak current of Level 1-ESD 2 kV is 7.5 A. A turn-on resistance of the general TVS is about 0.5 ohm. If the TVS applies to USB port, Vcc=5V. Under the ESD 2 kV stress, the ESD clamping voltage of Path 1=the turn-on voltage of Path 1 (6V)+ the peak current of Level 1-ESD 2 kV (7.5 A)*the turn-on resistance of the general TVS (0.5 ohm)=9.75 V. As a result, the breakdown voltage of the second diode 44 is larger than 9.75 V, namely 2 Vcc, lest the reverse breakdown of the second diode 44 occur. In other words, when the ESD level is enhanced, the breakdown voltage of the second diode 44 increases.

In conclusion, the Vcc pin and I/O pin are both designed with the cascade-diode circuit such that the Vcc pin and I/O pin can be exchanged. Therefore, the suppressor of the present invention can reduce the cost of chip development.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A transient voltage suppressor for multiple pin assignments, comprising
at least two cascade-diode circuits in parallel to each other, wherein one said cascade-diode circuit is connected with a high voltage, and wherein other said cascade-diode circuits are respectively connected with I/O pins, and wherein each said cascade-diode circuit further comprises
a first diode; and
a second diode cascaded to said first diode, wherein a node between said first diode and said second diode is connected with said high voltage or one said I/O pin; and
an electrostatic-discharge clamp element in parallel to each said cascade-diode circuit and connected with a low voltage, wherein an anode and a cathode of said first diode are respectively connected with a cathode of said second diode and said electrostatic-discharge clamp element, and wherein an anode of said second diode is connected with said low voltage, and wherein said high voltage minus said low voltage equals a voltage drop, and wherein a reverse breakdown voltage of said second diode is larger than double said voltage drop.

2. The transient voltage suppressor for multiple pin assignments according to claim 1, wherein said electrostatic-discharge clamp element is a Zener diode, and wherein a cathode of said Zener diode is connected with a cathode of said first diode, and wherein an anode of said Zener diode is connected with an anode of said second diode.

3. The transient voltage suppressor for multiple pin assignments according to claim 1, wherein when there is a plurality of said cascade-diode circuits, said high voltage is connected with said node of at least one said cascade-diode circuits, and said nodes of other said cascade-diode circuits are respectively connected with said I/O pins.

4. The transient voltage suppressor for multiple pin assignments according to claim 1, wherein said low voltage is a grounding voltage.
